(19) United States
(12) Patent Application Publication
(10) Pub. No.: US 2007/0177550 A1
(43) Pub. Date: Aug. 2, 2007

(54) Method for providing virtual private network services to mobile node in IPv6 network and gateway using the same

(76) Inventors: Hyeok Chan Kwon, Daejeon-city (KR); Jae Hoon Nah, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/634,688

(22) Filed: Dec. 6, 2006

(30) Foreign Application Priority Data
Jul. 12, 2005 (KR) 10-2005-0118786
Aug. 8, 2006 (KR) 10-2006-0074654

(51) Int. Cl. H04L 9/00; H04Q 7/00

(52) U.S. Cl. 370/331; 713/171

(57) ABSTRACT

Provided are a method for providing virtual private network (VPN) services to a mobile node (MN) in an IPv6 network and a gateway using the same. The method includes: performing IKE (Internet key exchange) negotiation with an MN (mobile node) which has performed handover, acquiring SA (security association) and then authenticating a terminal of the MN; receiving a BU (binding update) message from the MN and verifying the BU message, storing new position information of the MN, transmitting a BA (binding acknowledgement) message and performing mobility processing; if the mobility processing is completed, performing IPsec processing on packets which the MN transmits to a CN (correspondent node), and transmitting the packets; and re-configuring and transmitting packets so that packets which the CN transmits to a home address of the MN can be transmitted to a CoA (Care-of-Address) of the MN. A function performed by a home agent (HA) of Mobile IPv6 is performed so that IP mobility in VPN services can be provided and both mobility inside a VPN domain of the MN and mobility outside the VPN domain can be supported.

### CROSS-REFERENCE TO RELATED PATENT APPLICATIONS

This application claims the benefit of Korean Patent Application No. 10-2005-0118786, filed on Dec. 7, 2005 and 10-2006-0074654, filed on Aug. 8, 2006, in the Korean Intellectual Property Office, the disclosure of which incorporated herein in their entirety by reference.

### BACKGROUND OF THE INVENTION

1. Field of the Invention

The present invention relates to a virtual private network (VPN) gateway for providing VPN services to a mobile node (MN) for support mobility of the mobile node (MN) in an IPv6 network and a method for providing VPN services using the VPN gateway.

2. Description of the Related Art

The present invention utilizes an existing Mobile IPv6 technology for providing virtual private network (VPN) services to a mobile node (MN) and the prior art in the same field is as follows.

A standardized draft document of Internet Engineering Task Force (IETF) entitled “Mobile IPv4 Traversal Across IPsec-based VPN Gateways” proposes a technique in which HA is placed inside a VPN domain based on an IPv4 network and external Home Agent (HA) is additionally placed outside the VPN domain. In the technique, when a MN moves and position-registers to the external HA in which a safe channel has been previously formed with a VPN gateway, the external HA tunnels packets of the MN and passes the VPN gateway. The technique has the effect of providing VPN services to a mobile terminal. However, there is still a problem related to effectiveness in the technique. When the mobile terminal moves, a transmission path of packets should always pass external HA, a VPN gateway (GW), internal HA, and a VPN server. On the other hand, a technique proposed by the present invention provides a structure in which, even though the mobile terminal moves, it has the same transmission path as the transmission path of packets when VPN services are provided to an existing fixed terminal.

The invention entitled “Apparatus and Method for Providing Mobile Services in Multiprotocol Label Switching (MPLS) Virtual Private Network (VPN)” filed by Electronics and Telecommunications Research Institute (ETRI) relates to an MPLS network-based VPN. Specifically, the technique relates to an apparatus and a method for continuously providing mobile services to an MPLS VPN terminal even when a belonging terminal within a VPN site moves to other site. In MPLS, packets existing in one Internet protocol (IP) session are discriminated in a network layer and labels are attached to the front of a header of each packet so the packets can easily pass a router along a corresponding path. And, routing is performed by an MPLS router according to the labels. The core of the MPLS network-based VPN technique is to effectively perform packet transmission by isolating traffics between different VPNs using labels of MPLS. This invention is different in operating procedure from the present invention using an IP tunneling technique as an MPLS VPN technique using MPLS labels. In addition, this invention defines the scope of the invention by movement between VPN domains based on CE and is not a solution for remote access VPN services outside a VPN domain.

The invention entitled “Method and System for Supporting Internet Protocol Mobility of a Mobile Node in a Mobile Communication System” filed by Samsung Electronics Co., LTd. relates to a method for supporting Internet protocol (IP) mobility in a mobile communication system, in particular, to a method for supporting IP mobility between a mobile IP and a session IP (SIP) using a home address of a mobile terminal. The main objective of the invention is to provide a method for effectively supporting IP mobility of a mobile terminal in which both a mobile IP and a SIP are installed. Another objective of the invention is to provide a method for supporting IP mobility by which repeated procedures of a procedure of position-registering a mobile IP and a procedure of position-registering an SIP are optimized when the position of the mobile terminal is changed and a new IP address is allocated to the mobile terminal. The invention is effective to provide IP mobility in a mobile communication system and has no function of providing mobility regarding VPN services.

In addition, current VPN products do not support mobility of a terminal. This is because a VPN gateway does not recognize a newly-acquired address when the terminal moves. In an IPv6 network, when the terminal moves, a new address is allocated to the terminal through communication between a router and a peripheral node according to an auto-configuration technique. In a VPN gateway, since a terminal knows only initially-registered IP information, when a mobile terminal receives transmitted packets, an address in a source address field is not authenticated and corresponding packets are discarded.

### SUMMARY OF THE INVENTION

The present invention provides a method for supporting mobility to a mobile node (MN) even in a virtual private network (VPN) and a gateway using the same, and more particularly, provides a gateway (hereinafter, referred to as an “MVPN gateway”) for performing a function corresponding to a home agent (HA) of Mobile IPv6 in a VPN gateway.

According to an aspect of the present invention, there is provided a method for providing VPN (virtual private network) services of a gateway in an IPv6 network, the method including: performing IKE (Internet key exchange) negotiation with an MN (mobile node) which has performed handover, acquiring SA (security association) and then authenticating a terminal of the MN; receiving a BU (binding update) message from the MN and verifying the BU message, storing new position information of the MN, transmitting a BA (binding acknowledgement) message and performing mobility processing; if the mobility processing is completed, performing IPsec processing on packets which the MN transmits to a CN (correspondent node), and transmitting the packets; and re-configuring and transmitting packets so that packets which the CN transmits to a home address of the MN, can be transmitted to a CoA (Care-of-Address) of the MN.

According to another aspect of the present invention, there is provided a method for providing VPN (virtual private network) services between a gateway and an MN (mobile node) in an IPv6 network in which the MN, a VPN gateway and a CN (correspondent node) are connected to one another, the method including: providing SA (security association) after performing IKE (Internet key exchange) negotiation between the MN and the gateway; transmitting a BU (binding update) message to which an IPsec tunnel header generated based on the SA is added, to the gateway using the MN; performing IPsec processing and decrypting packets based on the SA using the gateway which has verified the BU message, and transmitting a BA (binding acknowledgement) message to the MN; if IPsec processing is performed on packets which the MN transmits to the CN and the packets are transmitted to the gateway, transmitting the packets to the CN which is a destination, by referring to binding cache information using the gateway; and re-configuring and transmitting packets so that packets which the CN transmits to a home address of the MN, can be transmitted to a Care-of-Address (CoA) of the MN using the gateway receiving the packets.

According to another aspect of the present invention, there is provided a gateway for providing VPN (virtual private network) services in an IPv6 network, the gateway including: an IPsec engine module processing ESP (encapsulating security payload) and an authentication overhead to perform IPsec processing with communication with a MN (mobile node); an encryption/decryption processing unit performing encryption/decryption processing and hash function processing used in IPsec and generating and verifying a message authentication code; a VPN service module providing VPN services if authentication of the MN is successfully performed; and a mobility processing & management module performing processing of an address of the MN and packets to perform the VPN services and outputting the address of the MN and the packets to the VPN service module.

### BRIEF DESCRIPTION OF THE DRAWINGS

The above and other aspects of the present invention will become more apparent by describing in detail exemplary embodiments thereof with reference to the attached drawings in which:

FIG. 1 illustrates a structure of the entire network according to the present invention;

FIG. 2 is a block diagram illustrating a structure of an MVPN gateway according to an embodiment of the present invention;

FIG. 3 is a flowchart illustrating a method for providing VPN services to a mobile node (MN) using the MVPN gateway illustrated in FIG. 2, according to an embodiment of the present invention;

FIG. 4 is a flowchart illustrating an operation of providing VPN services between the MVPN gateway and the MN according to an embodiment of the present invention.

FIG. 5 illustrates the entire execution procedure when the MN is initialized (is turn on) in a home domain and then moves to other domain, according to the present invention; and

FIG. 6 illustrates the entire execution procedure when the MN is initialized in an external network, according to the present invention.

### DETAILED DESCRIPTION OF THE INVENTION

The present invention will now be described more fully with reference to the accompanying drawings, in which exemplary embodiments of the invention are shown.

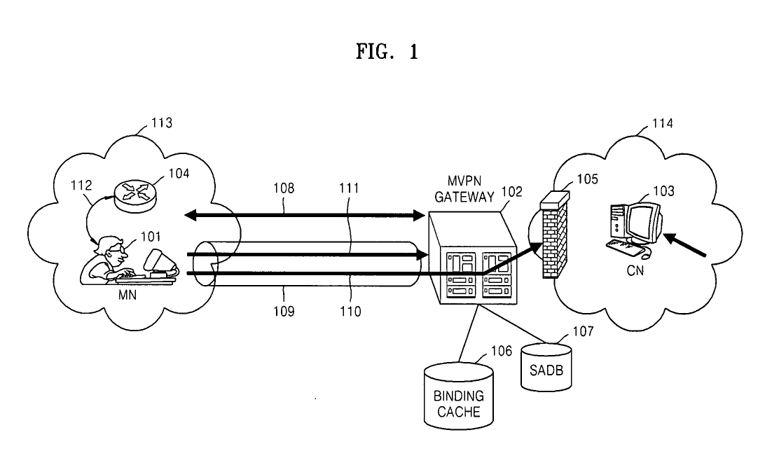

FIG. 1 illustrates a structure of the entire network according to the present invention. In order to provide virtual private network (VPN) services to support mobility of a terminal in an IPv6 network, a network system according to the present invention includes a mobile node 101 which is a mobile user terminal, a router 104 in a region in which the MN 101 moves, an MVPN gateway 102 for providing mobility of the MN 101 and VPN services, and a correspondent node (CN) 103 which is a communication object with the MN 101.

VPN equipment used in the present invention is a Layer 3 IPsec VPN and is assumed as VPN equipment for supporting IPv6 networking. VPN authentication technique is assumed to replace user authentication. A terminal authentication method is performed through Internet key exchange (IKE).

Elements including hardware and software for operating a system includes an MN 101, an MVPN gateway 102, a CN 103, a router 104, a firewall 105, a security association database (SADB) 107, and a binding cache (106), as illustrated in FIG. 1.

The MN 101 and the CN 103 are elements of Mobile IPv6 defined by the IETF RFC 3775 and can be used without any change of functions. The firewall 105 is used to protect a VPN domain 114. The firewall 105 passes only packets in which VPN connection-assented Internet protocol (IP) is used as a source address, and discards the other packets. The SADB 107 is a database which stores and manages security association (SA) for IPsec communication between the MN 101 and the MVPN gateway 102 and exists both in the MVPN gateway 102 and the MN 101. The binding cache 106 is information managed by the MVPN gateway 102 to manage a mobile address of the MN 101 and manages mapping information of a home address of the MN 101 and a Care-of-Address (CoA) that is set after movement of the MN.

The VPN domain 114 of FIG. 1 is also a home network of the MN 101. That is, in the present system, the home address of the MN 101 is as an address in the VPN domain 114 and a procedure of registering the home address of the MN 101 set to receive VPN services in the firewall 105 is required.

The MVPN gateway 102 which is the core of the present invention, has a structure in which a portion of functions of home agent (HA) of Mobile IPv6 is installed.

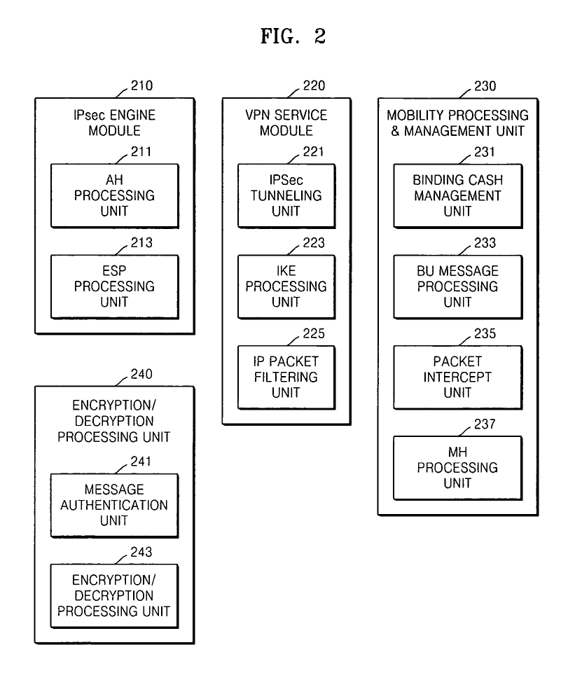

The MVPN gateway 102 according to an embodiment of the present invention will now be described with reference to FIG. 2.

An IPsec engine module 210 includes two execution units as functional modules for IPsec processing, that is, an authentication header (AH) processing unit 211 for performing AH processing and an encapsulating security payload (ESP) processing unit 213 for performing ESP processing.

An encryption/decryption processing unit 240 includes a message authentication code unit 241 which performs an encryption/decryption function and a hash function processing function used in IPsec and generates and verifies a message authentication code, and an encryption/decryption processing unit 243 which performs encryption/decryption processing. The IPsec engine module 210 and the encryption/decryption processing unit 240 are basic modules for IPsec processing and follow protocols defined by the RFC 3168, 2402, and 2406 of Internet Engineering Task Force (IETF).

A VPN service module 220 includes an IP packet filtering unit 225 which is a module for providing VPN services such as terminal authentication and layer 3 tunneling and filters IP packets, an IPsec tunneling unit 221 which processes IPsec tunneling, and an IKE processing unit 223 which performs IKE processing. Here, the IP packet filtering unit 225 does not operate when there is a firewall for protecting a VPN domain.

A mobility processing & management module 230 is added to existing VPN services and is a module for supporting mobility of a terminal. The mobility processing & management module 230 performs the function for supporting mobility among functions of HA of the Mobile IPv6 protocol. The mobility processing & management module 230 includes a binding cash management unit 231 which manages the home address and the CoA of the MN 101, performs IKE negotiation with the MN 101, acquires SA and then authenticates the mobile terminal, a binding update (BU) message processing unit 233 which verifies a BU message received from the MN 101 and stores new position information of the MN 101 and transmits a binding acknowledgement (BA) message, a packet intercept unit 235 which intercepts packets arrived at the home address of the MN 101, and a mobility header (MH) processing unit 237 which recognizes and processes an MH used in the Mobile IPv6 protocol.

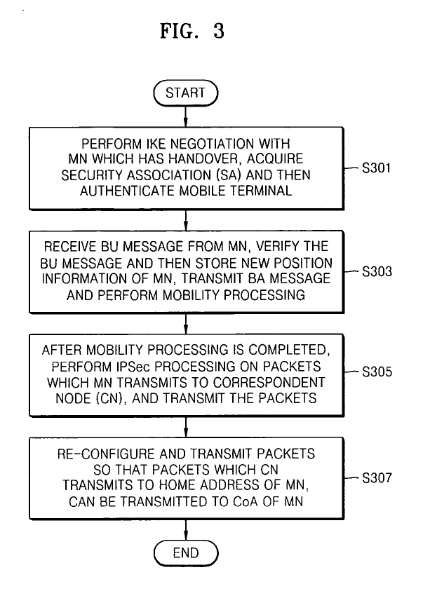

A method for providing VSN services according to an embodiment of the present invention will now be described with reference to FIGS. 3 through 6.

FIG. 3 is a flowchart illustrating a method for providing VPN services to a mobile node (MN) using the MVPN gateway illustrated in FIG. 2, according to an embodiment of the present invention.

In operation S301, the MVPN gateway performs Internet key exchange (IKE) negotiation with a MN which has performed handover, acquires security association (SA) and then authenticates a mobile terminal.

Next, a home address of the MN and a Care-of-Address (CoA) generated by handover of the MN are included and a binding update (BU) message to which an IPsec tunnel header generated based on SA is added, is received from the MN. After the SA is extracted from the received BU message, the IPsec tunnel header is removed, and packets are decrypted. And, in the decrypted packets, new position information of the MN is updated in a binding cache and then is transmitted to binding acknowledgement (BA) message in an IPsec tunnel mode in operation S303.

Now, packets which the MN transmits to a correspondent node (CN) are received, are IPsec-processed, are decrypted and decapsulated and then, are transmitted to the CN using the home address of the MN located in an inner header as a source address in operation S305.

Last, in operation S307 packets are re-configured and transmitted so that packets which the CN transmits to the home address of the MN, can be transmitted to the CoA of the MN.

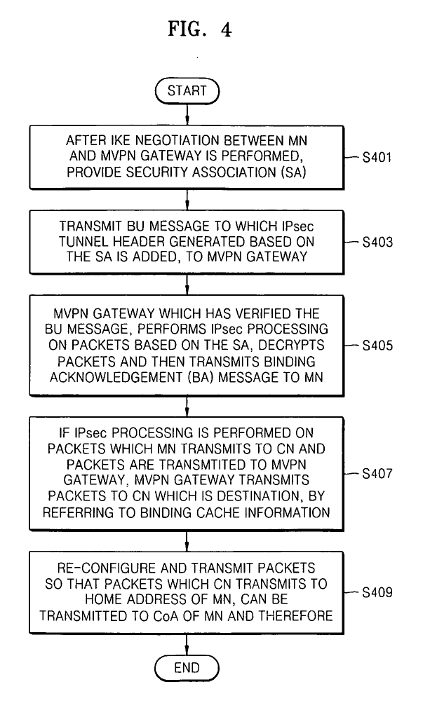

A mutual operation between the MN and the MVPN gateway will now be described with reference to FIG. 4. After IKE negotiation between the MN and the MVPN gateway is performed, security association (SA) is provided in the MN and the MVPN gateway in operation S401. A binging update (BU) message to which an IPsec tunnel header generated based on the SA in this state is added, is transmitted to the MVPN gateway and mobility processing starts being performed in operation S403. Now, the MVPN gateway which has verified the BU message, performs IPsec processing on packets based on the SA, decrypts the packets and then transmits a binding acknowledgement (BA) message to the MN in operation S405.

If binding is performed in this way and then packets which the MN transmits to a correspondent node (CN), are IPsec-processed and are transmitted to the MVPN gateway, the MVPN gateway transmits the packets to the CN which is a destination, by referring to binding cache information in operation S407, and packets are re-configured and transmitted so that packets which the CN transmits to the home address of the MN, can be transmitted to a CoA of the MN and therefore, the MVPN gateway terminates mobility processing in operation S409. A processing procedure illustrated in FIG. 4 will now be described in greater details according to operations.

In order to explain an operating procedure of the present system, referring back to FIG. 1, when the MN 101 is initialized in an external network 113 which is a VPN domain 114 or when the MN 101 moves to the external network 113 after being initialized inside the VPN domain 114, the MN 101 detects its own movement based on information received from the adjacent router 104 according to an IPv6 protocol operation and generates its own address (112). The information received from the adjacent router 104 is a router advertisement message and includes prefix information of the router 104. An auto-configuration procedure is the same as that of IETF RFC 2460.

Next, in order to register the generated address in the MVPN gateway 102, firstly, IKE negotiation (108) with the MVPN gateway 102 is tried. During the IKE negotiation, the MVPN gateway 102 authenticates an MN terminal, negotiates SA for IPsec communication between the MVPN gateway 102 and the MN terminal and retains SA at its both ends. Next, the MN 101 generates a binding update (BU) message (111) including its own home address and a newly-allocated Care-of-Address (CoA) and transmits the BU message to the MVPN gateway 102, so as to inform its own mobile information to the MVPN gateway 102. When generating the BU message, the MN 101 attaches an IPsec tunnel header to the BU message using the SA shared through IKE. Thus, the BU message is protected at an IPsec tunnel (109).

The MVPN gateway 102 which receives the BU message, verifies the IPsec tunnel header and detaches it from the BU message, and inquires the SADB 107 and extracts SA from the SADB 107, so as to decrypt packets. The MVPN gateway 102 performs IPsec reception processing on the packets based on the extracted SA information, verifies the IPsec tunnel header and detaches it from the BU message and then decrypts packets. The MVPN gateway 102 inspects the decrypted packets, that is, BU packets, and updates new position information of the MN 101 in its own binding cache. The MVPN gateway 102 transmits binding acknowledgement (BA) packets to the MN 101, so as to inform a user that BU has been normally processed. The MVPN gateway 102 transmits the BA packets also in an IPsec tunnel mode.

When the MN 101 transmits the packets to a destination in the VPN domain 114 thereafter, the MVPN gateway 102 replaces a source address of the packets with a home address of the MN 101 by referring to its own binding cache information and then transmits the home address of the MN 101 to the destination. Thus, there is no problem in passing the firewall 105. Regarding a source address of packets, when the source address of packets arrives at the MVPN gateway 102, it is a CoA (an outer address of a tunneling header) of the MN 101 and is a home address of the MN 101 after the packets are processed by the MVPN gateway 102. Here, the tunneling header is removed.

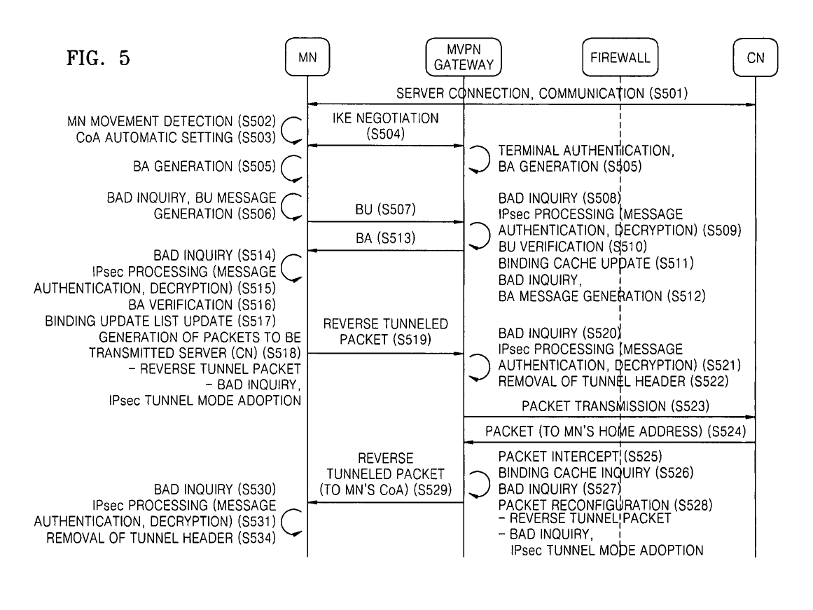

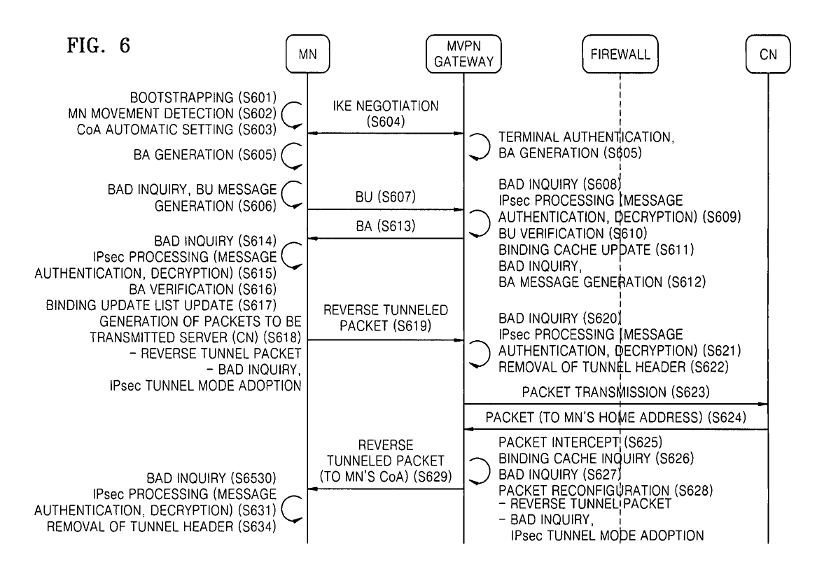

FIG. 5 illustrates the entire execution procedure when the MN is initialized (is turn on) in a home domain and then moves to other domain, according to the present invention, and FIG. 6 illustrates the entire execution procedure when the MN is initialized in an external network, according to the present invention.

The MN which makes communication with a CN at an initial stage (501), detects movement and then sets a CoA automatically in operations S502 and S503. The MN starts IKE negotiation with the MVPN gateway in operation S504. As a result, the MVPN gateway authenticates a terminal and then generates binding acknowledgement (BA) and the MN also generates BA in operation S505. As a result, the MVPN gateway inquires a database, performs IPsec processing including message authentication and decryption and verifies a binding update (BU) message. If the verification is successfully performed, a binding cache is updated and then, a BA message is generated and is transmitted to the MN in operations S508 through S513. The MN which receives the BA message, inquires the database, performs IPsec processing including message authentication and decryption and verifies the BA message. If the verification is successfully performed, a binding update list is updated, packets to be transmitted to the CN are generated and are transmitted to the MVPN gateway in an IPsec tunnel mode in operations S514 through S519.

The MVPN gateway which receives the packets, performs IPsec processing agin and then removes a tunnel header and transmits packet data to the CN in operations S520 through S523. The MVPN gateway which receives packets to be transmitted to the home address of the MN by the CN, intercepts the packets, inquires a binding cache and then re-configures the packets and transmits the re-configured packets to the CoA of the MN. The MN which receives the packets, performs IPsec processing again and then removes the tunnel header and obtains pure data in operations S524 through S534 FIG. 6 illustrates the case where the MN is initialized in an external network. Only an operation S601 in which the MN performs bootstrapping at an initial stage, is added to FIG. 6 and the other operations are the same as those of FIG. 5. Thus, a detailed description thereof will be omitted for avoiding duplication.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in the method of providing virtual private network (VPN) services to a mobile node (MN) in an IPv6 network and a gateway using the same according to the present invention, a function performed by a home agent (HA) of Mobile IPv6 is performed so that IP mobility in VPN services can be provided and both mobility inside a VPN domain of the MN and mobility outside the VPN domain can be supported.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for providing VPN (virtual private network) services of a gateway in an IPv6 network, the method comprising:
performing IKE (Internet key exchange) negotiation with an MN (mobile node) which has performed handover, acquiring SA (security association) and then authenticating a terminal of the MN;
receiving a BU (binding update) message from the MN and verifying the BU message, storing new position information of the MN, transmitting a BA (binding acknowledgement) message and performing mobility processing;
if the mobility processing is completed, performing IPsec processing on packets which the MN transmits to a CN (correspondent node), and transmitting the packets; and
re-configuring and transmitting packets so that packets which the CN transmits to a home address of the MN, can be transmitted to a CoA (Care-of-Address) of the MN.

2. The method of claim 1, wherein the BU message comprises a home address of the MN and a CoA (Care-of-Address) generated by handover of the MN.

3. The method of claim 2, wherein an IPsec tunnel header generated based on the SA (security association) is added to the the BU message

4. The method of claim 1, wherein the receiving of a BU (binding update) message from the MN and the verifying of the BU message, the storing of new position information of the MN, the transmitting of a BA (binding acknowledgement) message and the performing of mobility processing comprises:
extracting the SA from the BU message;
removing an IPsec tunnel header and decrypting packets based on the extracted SA;
updating new position information of the MN in a binding cache in the decrypted packets; and
transmitting the new position information to the BA message in an IPsec tunnel mode.

5. The method of claim 1, wherein, if the mobility processing is completed, the performing of IPsec processing on packets which the MN transmits to a CN (correspondent node), and the transmitting of the packets comprises:
receiving packets which the MN transmits to the CN; and
decrypting and decapsulating the received packets by performing IPsec processing on the received packets and then transmitting the packets to the CN using the home address of the MN located in an inner header as a source address.

6. The method of claim 1, wherein the re-configuring and the transmitting of packets so that packets which the CN transmits to a home address of the MN, can be transmitted to a CoA (Care-of-Address) of the MN comprises:
intercepting the packets transmitted to the MN; and
setting a source address of an outer header of the packets as an address of the gateway and setting a destination address of the outer header as a CoA of the MN and then transmitting the packets using IPsec.

7. A method for providing VPN (virtual private network) services between a gateway and an MN (mobile node) in an IPv6 network in which the MN, a VPN gateway and a CN (correspondent node) are connected to one another, the method comprising:
providing SA (security association) after performing IKE (Internet key exchange) negotiation between the MN and the gateway;
transmitting a BU (binding update) message to which an IPsec tunnel header generated based on the SA is added, to the gateway using the MN;
performing IPsec processing and decrypting packets based on the SA using the gateway which has verified the BU message, and transmitting a BA (binding acknowledgement) message to the MN;
if IPsec processing is performed on packets which the MN transmits to the CN and the packets are transmitted to the gateway, transmitting the packets to the CN which is a destination, by referring to binding cache information using the gateway; and
re-configuring and transmitting packets so that packets which the CN transmits to a home address of the MN, can be transmitted to a Care-of-Address (CoA) of the MN using the gateway receiving the packets.

8. The method of claim 7, before the providing of SA (security association) after performing IKE (Internet key exchange) negotiation between the MN and the gateway, further comprising
registering the home address of the MN in a firewall for protecting the network.

9. The method of claim 7, wherein the providing of SA (security association) after performing IKE (Internet key exchange) negotiation between the MN and the gateway comprises:
generating a CoA (Care-of-Address) address generated by handover using the MN; and
authenticating the MN, negotiating the SA with the MN and storing the SA during the IKE negotiation using the gateway.

10. The method of claim 7, wherein the performing of IPsec processing and the decrypting packets of based on the SA using the gateway which has verified the BU message, and the transmitting of a BA (binding acknowledgement) message to the MN comprises:
extracting the SA from the BU message;
removing an IPsec tunnel header and decrypting packets based on the extracted SA;
updating new position information of the MN in a binding cache in the decrypted packets; and
transmitting the new position information to the BA message in an IPsec tunnel mode.

11. The method of claim 7, wherein, if IPsec processing is performed on packets which the MN transmits to the CN and the packets are transmitted to the gateway, transmitting the packets to the CN which is a destination, by referring to binding cache information using the gateway comprises:
receiving packets which the MN transmits to the CN; and
decrypting and decapsulating the packets by performing IPsec processing on the received packets and then transmitting the packets to the CN using the home address of the MN located in an inner header as a source address.

12. The method of claim 7, wherein the re-configuring and transmitting of packets so that packets which the CN transmits to a home address of the MN, can be transmitted to a Care-of-Address (CoA) of the MN using the gateway receiving the packets comprises:
intercepting the packets transmitted to the MN; and
setting a source address of an outer header of the packets as an address of the gateway and setting a destination address of the outer header as a CoA of the MN and then transmitting the packets using IPsec.

13. A gateway for providing VPN (virtual private network) services in an IPv6 network, the gateway comprising:
an IPsec engine module processing ESP (encapsulating security payload) and an authentication overhead to perform IPsec processing with communication with a MN (mobile node);
an encryption/decryption processing unit performing encryption/decryption processing and hash function processing used in IPsec and generating and verifying a message authentication code;
a VPN service module providing VPN services if authentication of the MN is successfully performed; and
a mobility processing & management module performing processing of an address of the MN and packets to perform the VPN services and outputting the address of the MN and the packets to the VPN service module.

14. The gateway of claim 13, wherein the VPN service module comprises:
an IPsec tunneling unit processing IPsec tunneling; and
an IKE processing unit performing IKE negotiation with the MN.

15. The gateway of claim 14, wherein the VPN service module further comprises an IP packet filtering unit filtering packets which the MN transmits or receives, if there is no firewall in the IPv6 network.

16. The gateway of claim 13, wherein the mobility processing & management module comprises:
a binding cash management unit authenticating the MN after performing IKE negotiation with the MN and acquiring SA;
a BU (binding update) message processing unit verifying a BU message received from the MN, storing new position information of the MN, and transmitting a BA (binding acknowledgement) message;
a packet intercept unit performing IPsec processing on packets transmitted or received between the MN and the CN; and
an MH (mobility header) processing unit processing an MH.

17. The gateway of claim 16, wherein the BU message comprises a home address and Care-of-Address (CoA) generated by handover of the MN and an IPsec tunnel header generated based on the SA is added to the BU message.

18. The gateway of claim 16, wherein the BU message processing unit extracts SA from the BU message, removes an IPsec tunnel header and decrypts packets based on the extracted SA, updates new position information of the MN in a binding cache in the decrypted packets, and then transmits the new position information to the BA message in an IPsec tunnel mode.

19. The gateway of claim 16, wherein the packet intercept unit comprises:
a first packet intercept unit decrypting and decapsulating the packets by performing IPsec processing on the packets which the MN transmits to a CN (correspondent node), and then transmitting the packets to the CN using the home address of the MN located in an inner header as a source address; and
a second packet intercept unit intercepting the packets transmitted to the MN and setting a source address of an outer header of the packets as an address of the gateway and setting a destination address of the outer header as a CoA of the MN and then transmitting the packets using IPsec.
